(19) United States
(12) Patent Application Publication
(10) Pub. No.: US 2012/0311045 A1
(43) Pub. Date: Dec. 6, 2012

(54) NOTIFICATION SERVICES TO ONE OR MORE SUBSCRIBER DEVICES

(76) Inventor: Dany SYLVAIN, Gatineau (CA)

(21) Appl. No.: 13/149,278

(22) Filed: May 31, 2011

(51) Int. Cl. G06F 15/16

(52) U.S. Cl. 709/206

(57) ABSTRACT

Methods, systems, and computer readable media for providing notification services to one or more subscriber devices are disclosed. One exemplary method comprises receiving, from a notification source, a notification directed to a first user device associated with a subscriber. The method further includes accessing filtering criteria associated with the subscriber to determine whether to deliver the notification to at least one user device associated with the subscriber and delivering a notification message associated with notification to the at least one user device if the filtering criteria is satisfied.

### TECHNICAL FIELD

The subject matter described herein relates to the combining and optimizing of notification services. More specifically, the subject matter relates to methods, systems, and computer readable media for providing notification services to a subscriber device.

### BACKGROUND

The number and manner of communication methods have significantly increased over the years and continue to do so. The various communication methods pertain to real time (e.g., voice and video call) communications methods, near real time (e.g., SMS messaging and instant messaging) communication methods, and non-real time (e.g., email and voicemail) communication methods. Other communication methods being utilized today include video streaming, news feeds, blogs, tweets, social networks, and the like. With the proliferation of communication means and information sources, managing the above mentioned communications methods is becoming an ever growing complex task. One specific problem is how to receive timely information while minimizing interruptions and distractions to the subscriber user. Currently, a user may utilize a computer that is provisioned with multiple notification clients/agents (e.g., one agent for calls, one agent for each social network application, one agent for email, one agent for RSS feeds, etc.), each of which needs to be installed, configured, and frequently updated. Similarly, the same user may have similar notification agents provisioned on a mobile device where the more limited mobile resources may be consumed.

Accordingly, a need exists for improved methods, systems, and computer readable media for providing notification services to one or more subscriber devices.

### SUMMARY

Methods, systems, and computer readable media for providing notification services to one or more subscriber devices are disclosed. One exemplary method comprises receiving, from a notification source, a notification directed to a first user device associated with a subscriber. The method further includes accessing filtering criteria associated with the subscriber to determine whether to deliver the notification to at least one user device associated with the subscriber and delivering a notification message associated with notification to the at least one user device if the filtering criteria is satisfied.

The subject matter described herein may be implemented in software, in combination with hardware and/or firmware. For example, the subject matter described herein may be implemented in software executed by a processor. In one exemplary implementation, the subject matter described herein for providing notification services to one or more subscriber devices may be implemented using a non-transitory computer readable medium to having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

The subject matter described herein will now be explained with reference to the accompanying drawings of which:

FIG. 1 is a block diagram illustrating an exemplary system for providing notification services to one or more subscriber devices according to an embodiment of the subject matter described herein;

FIG. 2 is a block diagram illustrating an exemplary notification service node that provides notification services to one or more subscriber devices according to an embodiment of the subject matter described herein;

FIG. 3 is a flow chart illustrating a process for providing notification services to one or more subscriber devices according to an embodiment of the subject matter described herein;

FIG. 4 is a message flow diagram illustrating the delivery of a notification to a plurality of subscriber devices according to an embodiment of the subject matter described herein;

FIG. 5 is a message flow diagram illustrating the delivery of a notification designated as urgent to a plurality of subscriber devices according to an embodiment of the subject matter described herein;

FIG. 6 is a message flow diagram illustrating the filtering and buffering of a notification according to an embodiment of the subject matter described herein; and

FIG. 7 is a message flow diagram illustrating the delivery of a notification that includes a disposition option to a subscriber device according to an embodiment of the subject matter described herein.

### DETAILED DESCRIPTION

The subject matter described herein includes methods, systems, and computer readable media for providing notification services to one or more subscriber devices. Multiple notification sources that provide notification services (e.g., calls, messages, emails, message waiting indication (MWI) messages, alerts, RSS feeds, etc.) are forwarded to a notification service node (NSN) via different application programming interfaces (APIs). The NSN may then filter the notifications based upon a combination of subscription criteria and system criteria. Notifications that meet the filter criteria are subsequently forwarded to the intended subscriber via one or more user devices (e.g., computer, mobile, tablet, television, etc.). Notifications not immediately sent to the subscriber may be buffered by the NSN for later delivery. The buffered notifications may ultimately be sent to user devices either individually or in a grouped manner. Similarly, NSN may be configured to facilitate a delay feature that permits the NSN to issue notifications that have been delayed (and stored in a buffer) in order to minimize user disruption, mobile battery usage, and the like. The NSN may also be configured to apply and utilize different criteria and different notification methods for each of the different user devices belonging to a subscriber. Notification messages may also include disposition options, which, when activated by a receiving subscriber, can trigger specific actions that are directed back to the originating notification source (e.g. selecting an option that disposes an incoming call by indicating an alternate number to which the call is to be forwarded).

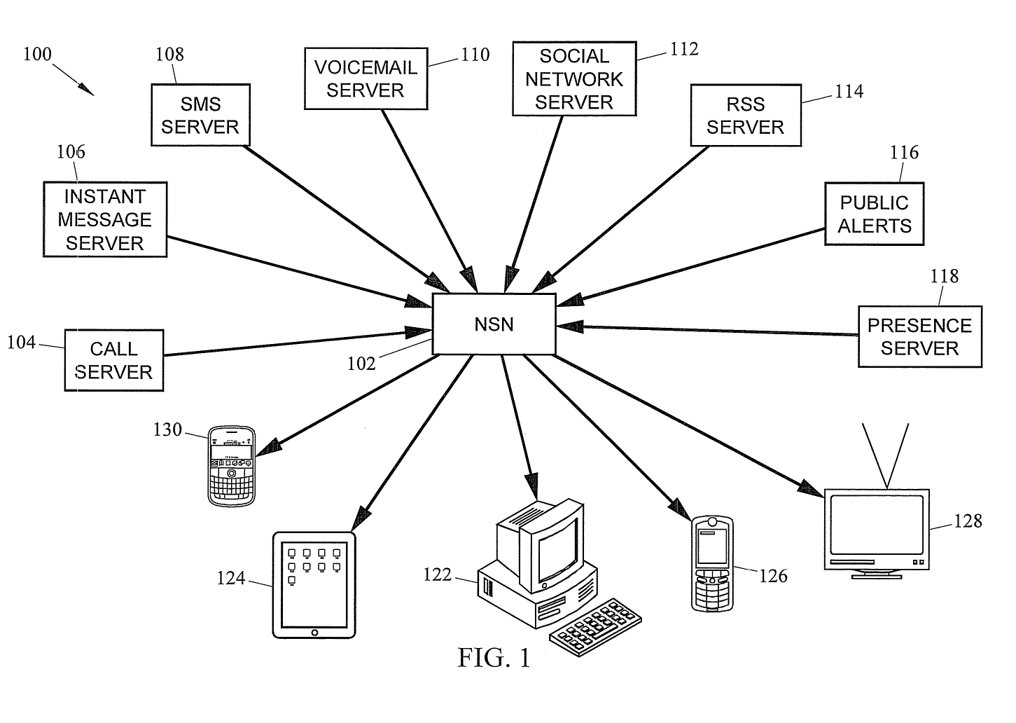

FIG. 1 depicts an exemplary system 100 for providing notification services to one or more subscriber devices according to an embodiment of the subject matter described herein. System 100 includes a notification service node (NSN) 102 that may be configured to communicate with a plurality of notification sources 104-118. In one embodiment, NSN 102 may receive notifications from any of a call server 104, an instant message (IM) server 106, a short messaging service (SMS) server 108, a voicemail server 110, a social network server 112, an RSS server 114, a public service alerts system server 116, and a presence server 118. For example, NSN 102 may receive an inbound call from a call server 104, NSN 102 may receive a notification from voice mail server 110 indicating that a message is waiting in voice mail, NSN 102 may receive a notification indicating the number of messages that are stored at the voice/video mail server (not shown), and/or NSN 102 may receive a notification indicating the source of the voice/video messages. NSN 102 may also receive a notification from an SMS/MMS server 108 that sends notifications relating to received text or media messages. NSN 102 may be further configured to receive instant messages from one or more proprietary sources (e.g., Yahoo) or standardized sources, such as a source that uses XMPP, SIP, IMS, and/or RCS protocols. NSN 102 may also receive communications from an email server (not shown), which may be configured to determine the source of the notification, to determine the subject of the notification, and to determine if the notification is flagged in any manner. NSN 102 may also be configured to receive RSS feeds (from RSS server 114) and public alerts (from a public alert server 116) on a periodic basis. For example, the public alerts or RSS feed may include information regarding breaking news, the current weather, and sports highlights or scores. Similarly, NSN 102 may communicate with one or more social network servers 112 in order to receive new updates from friends or receive changes in the availability/connectivity status of friends.

In one embodiment, notification sources 104-118 may be interfaced with NSN 102 via existing protocols, such as SMTP, XMPP, SIP, or via some other API, such as a web service. Notifications may be issued from notification sources 104-118 in real time (e.g. call notification), in near real time (e.g. IM), or delayed (e.g., email, RSS feed). In one embodiment, notifications from notification sources 104-118 may be characterized or designated with different importance levels which may be used to indicate the significance of the notification (e.g., notice of a breaking world news event). For example, importance levels may be characterized as low, normal, important, critical, and the like. Similarly, notifications from notification sources 104-118 may be characterized or designated with different priority levels which may be used to indicate the how fast a response to the notification may be required (e.g., a reminder to pay a utility bill). In one embodiment, priority levels may be characterized as low, normal, urgent, emergency, and the like. Although FIG. 1 only depicts eight notification sources, any number (i.e., additional or fewer) of notification sources may be connected to NSN 102 without departing from the scope of the present subject matter. NSN 102 may also be communicatively connected to a plurality of user devices 122-130 that may be associated with a single notification service subscriber (i.e., a user that subscribes with a service provider to receive issued notifications via NSN 102). In one embodiment, the user devices may include a personal computer (PC) 122, a tablet PC 124, a mobile phone 126, a television 128, and a personal digital assistant (PDA) 130. Although FIG. 1 only depicts six user devices associated with a single subscriber, any number (i.e., additional or fewer) of user devices may be connected to NSN 102 without departing from the scope of the present subject matter. Although not shown in FIG. 1, other user devices associated with one or more other notification service subscribers may also be communicatively connected to NSN 102.

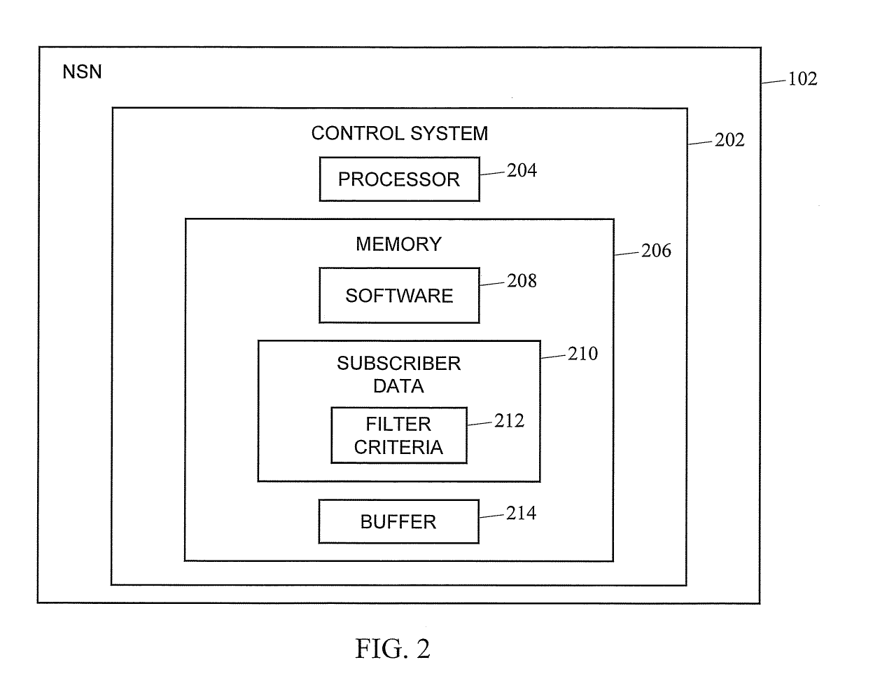

FIG. 2 depicts an exemplary NSN 102 that may be used to provide notification service in system 100. Notably, NSN 102 in FIG. 2 includes a control system 202 and a memory 206. In one embodiment, memory 206 includes a software module 208, a subscriber database 210 that includes a set of filter criteria 212 for each subscriber, and a buffer 214. Control system 202 includes a processing unit or processor 204 that is configured to access, process, and/or execute each of notification service software module 208, subscriber data database 210, filter criteria 212, and buffer 214. In one embodiment, notification service software module 208 includes software based instructions that may be used to operate the methods and processes described below. Subscriber data database 210 may contain a number of entries, each of which includes subscriber identification information and user devices utilized and designated by the subscriber to receive notification messages. In one embodiment, NSN 102 may be configured to support a parallel notification service to all user devices associated with a single subscriber (i.e., each of the user devices of the subscriber receive the same notification message, even though the original notification was directed to single user device associated with the subscriber). Specifically, NSN 102 may send multiple copies of a received notification to a plurality of user devices associated with the subscriber if the subscriber indicated such a user preference. In one embodiment, these user device preferences are maintained in subscriber database 210.

Filter criteria 212 may contain (for each subscriber) a plurality of rules, parameters, conditions, and other criteria which must be met in order for a notification received by NSN 102 from a notification source to be forwarded to a user device of a subscriber. In one embodiment, filter criteria 212 may be accessed and processed via software module 208, which may be executed by a processor 204 in NSN 102. Filter criteria 212 may be based on factors such as user rules, user status, current device connectivity, and the like. For example, filter criteria 212 may be provisioned with user rules such as 1) do not disturb (i.e., do not forward a notification under any circumstance), 2) only forward a notification if certain threshold urgency levels are met (e.g., the notification is designated with an emergency level), 3) transmitting notifications after a minimum delivery interval (e.g., forward notifications to one or more user devices belonging to a subscriber every 15 minutes), 4) rules specifying different delivery intervals depending on the type of notification (e.g., RSS every hour and SMS messages every 10 minutes), and 5) rules specifying a maximum daily data size.

Filter criteria 212 may also be provisioned with user status criteria. In one embodiment, a subscriber's presence status and calendar status may be included in filter criteria 212. For example, the presence status associated with a subscriber may indicate that the subscriber is connected, busy, idle, or the like via one or more user devices. Similarly, calendar status associated with a subscriber may indicate that the subscriber is busy, on vacation, unavailable, or free/available on a given hour or day.

In one embodiment, a subscriber may establish filtering criteria based on current device connectivity. For example, filtering criteria 212 may include parameters that consider whether a user device is connected to a particular network, such as a cellular network, WiFi network, broadband network, and the like. For example, the filtering criteria may indicate that a notification message may be provided to a user device (e.g., a cellular phone) if the user device is connected to a WiFi network. Thus, if the user device is only serviced by a cellular network, the notification may instead be buffered until the user device establishes a connection with a WiFi network.

In one embodiment, filtering may be conducted independently for each of a subscriber's user devices that are capable of receiving a notification message. Namely, each of a subscriber's PC, mobile device, PC tablet, and television may have with its own distinct separate filtering criteria 212. For example, NSN 102 may determine, after accessing filtering criteria associated with a particular recipient subscriber, that a particular notification message (e.g., an SMS message or a sports score alert) is only to be sent to the subscriber's mobile device and not to the subscriber's other user devices. However, if the subscriber receives a notification indicating the existence of a new tweet message (e.g., a social network message has been posted), filter criteria 212 may specify that the notification message only be sent to the subscriber's PC and television (i.e., not the subscriber's mobile device). Notably, filter criteria 212 may include rules that specify that a particular notification type (e.g., call notification, SMS, tweet message, weather alert, etc.) may be forwarded to any or all of a subscriber's user devices.

In one embodiment, NSN 102 may be configured to deliver or forward notification messages based on the received notifications to at least one subscriber user device using one or more methods. Namely, NSN 102 may forward a notification message based on the type of user device designated to receive the notification. For example, NSN 102 may forward a notification as a computer popup message via a system tray application if filtering criteria 212 indicates that the notification received from the notification source is to be delivered to the subscriber's PC. Filtering criteria 212 may also indicate that NSN 102 is configured to forward an SMS/MMS message including the notification message to a user device that is connected to a cellular network (e.g., a cellular phone, a tablet PC, and the like). In one embodiment, filtering criteria 212 may specify that NSN 102 should utilize a television or set-top box (STB) application to present the notification message to the subscriber if the notification message is to be presented to the subscriber on a television display. Filtering criteria 212 may also indicate that NSN 102 should forward a notification message via a mobile notification application if the designated receiving user device is a mobile device (e.g., a cellular phone or PDA).

In one embodiment, NSN 102 may be configured to forward a notification message that includes at least one disposition option. For example, a notification source may provide a notification (which is directed to particular subscriber) to NSN 102, wherein the notification may include one or more disposition options. NSN 102 may then determine via filter criteria stored in the subscriber database 210 which user devices associated with the subscriber are designated to receive the notification from the notification source. If a designated user device is unable to present the disposition option(s) to the subscriber (e.g., via a display interface) or the user device is incapable of providing the subscriber the ability to select a disposition option, then NSN 102 may send the notification message to the user device without the disposition options. However, if NSN 102 determines that the receiving user device is capable of presenting the disposition options(s) to the subscriber, then NSN 102 forwards the notification message with the included disposition options to the subscriber. Upon receiving the notification message, the subscriber may select one or more disposition options (i.e., disposition user input). Exemplary disposition options that may be incorporated with a notification message and selected by the subscriber includes 1) an open option (direct link to get more details), 2) a delete option, 3) a close option, 4) a call action option (e.g., forward, ignore, forward to voicemail, hold, etc.), a text message option, and the like. Upon selection, the disposition user input may be sent to the originating notification source via NSN 102 for action.

In one embodiment, NSN 102 may receive a notification from a notification source that cannot be delivered immediately to the intended subscriber. For example, NSN 102 may access filter criteria 212 and determine that the subscriber is unavailable or that some other predefined condition has not been met. In this scenario, the notification is buffered for a later delivery when filter criteria 212 is changed and/or is ultimately satisfied. For example, NSN 102 may send a buffered notification to the subscriber upon 1) the expiration of a time delay as specified in filter criteria 212, 2) the change in user status (e.g., presence status) specified in filter criteria 212, and 3) the change in user device status (e.g., roaming from a cellular network to a WiFi network) as specified in filter criteria 212.

In one embodiment, a notification issued by a notification source may include an advertisement. For example, NSN 102 may receive a notification that includes an advertisement from a notification source. The advertisement included in a notification may be based on the content of current or past notifications sent to the subscriber. For example, if a notification is received in the form of a test string (e.g. SMS) and includes keywords like lunch, dinner, etc., then the advertisement included could be associated with a restaurant. After accessing filter criteria 212, NSN 102 may send a notification message with the advertisement to the intended recipient. Notably, the advertisement will be presented to the subscriber via the display of the receiving user device (e.g., television screen, mobile device display, PC monitor, and the like).

In one embodiment, a notification may be reviewed and acted on by the subscriber using an alternate access method, such a user web portal accessed via a PC, mobile device, tablet PC, and the like. All notifications received over a period of time can be archived by NSN 102 and retrieved via a user web portal. The retrieved notifications may be grouped or sorted based on type, source, priority, time of receipt, delivery status, or the like. Similarly, a subscriber may use the web portal or a similar access method to: 1) add, delete, and modify notification sources in subscriber database 210, 2) add, delete, and modify filtering rules in filter criteria 212, and 3) add, delete, and modify user devices for receiving notifications in subscriber database 210.

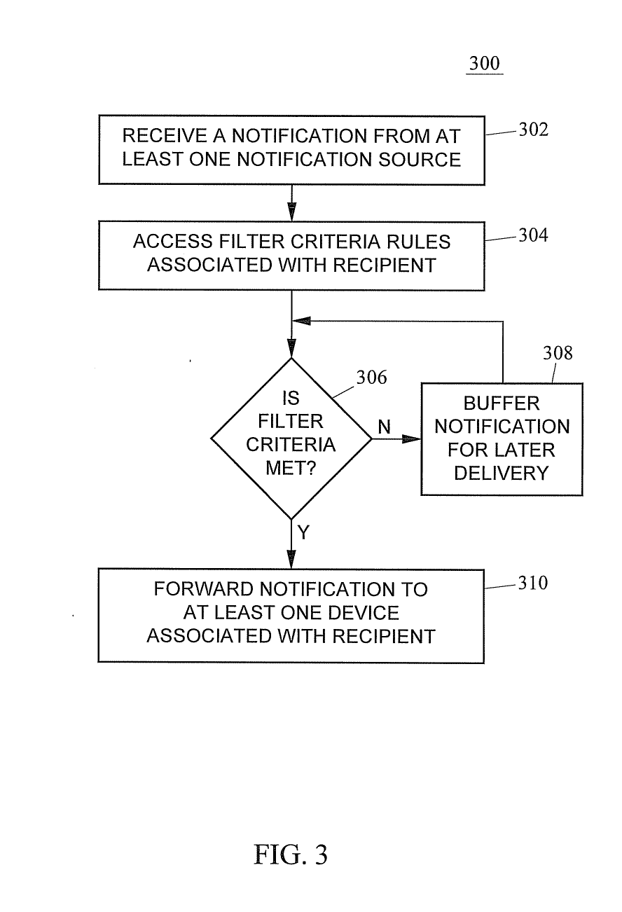

FIG. 3 is a flow chart illustrating a method 300 for providing notification services to one or more subscriber devices according to an embodiment of the subject matter described herein. In block 302, a notification from at least one notification source is received. In one embodiment, NSN 102 receives a notification directed to a first user device associated with a recipient subscriber from one or more of notification sources 104-118.

In block 304, filter criteria rules associated with the intended recipient (e.g., the subscriber) are accessed. In one embodiment, NSN 102 determines the intended recipient of the one or more notifications and accesses filter criteria 212. For example, NSN 102 may access the filter criteria associated with the intended subscriber recipient and initiates the filtering process.

In block 306, a determination is made as to whether the filter criteria are met. In one embodiment, NSN 102 processes filter criteria 212 to determine whether the notification should be delivered to one or more subscriber user devices. If the filter criteria are met, then method 300 continues to block 310. If the filter criteria are not met, then method 300 proceeds to block 308 where the notification is buffered by NSN 102 for later delivery. One the notification is buffered, NSN 102 may be configured to periodically check filter criteria 212 to determine if the filter criteria (e.g., rules) associated with the subscriber has changed or has been satisfied.

In block 310, the notification message is sent to at least one user device associated with the receiving subscriber. In one embodiment, NSN 102 sends the notification message to one or more user devices associated with the subscriber user. For example, NSN 120 may be required to translate the notification into a protocol recognized by each user device designated to receive the notification. In one embodiment, the notification message is sent to the originally intended user device (e.g., first user device) or the original user device in addition to other user devices associated with the subscriber. In another embodiment, the notification message is not sent to the originally intended user device, but is instead sent to other user devices associated with the subscriber (e.g., as determined by filter criteria 212).

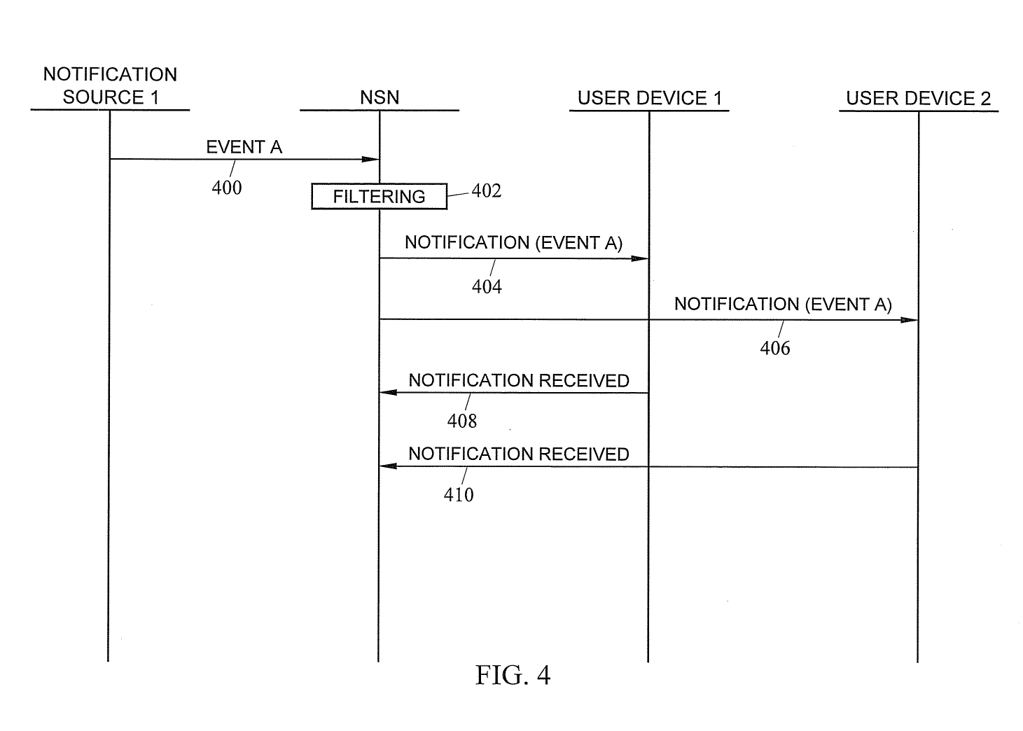

FIG. 4 is a message flow diagram illustrating the delivery of a notification to a plurality of subscriber devices according to an embodiment of the subject matter described herein. For example, a notification source sends, to NSN 102, a notification (message 400) that indicates that an Event A has occurred. Upon receiving the notification, NSN 102 conducts a filtering process (block 402) to determine whether the notification is to be delivered to the intended recipient's user devices, e.g., user device 1 and user device 2. User device 1 and user device 2 may include any of the user devices 120-128 shown in FIG. 1. In FIG. 4, NSN 102 accesses subscriber database 210 and determines that the notification should be delivered to each of user device 1 and user device 2 (block 402). Accordingly, NSN 102 sends a notification message (messages 404 and 406) indicating Event A occurred to each of user device 1 and user device 2. FIG. 4 also illustrates that each of user device 1 and user device 2 sends an acknowledgement message (messages 408 and 410) to NSN 102 in response to receiving the notification messages.

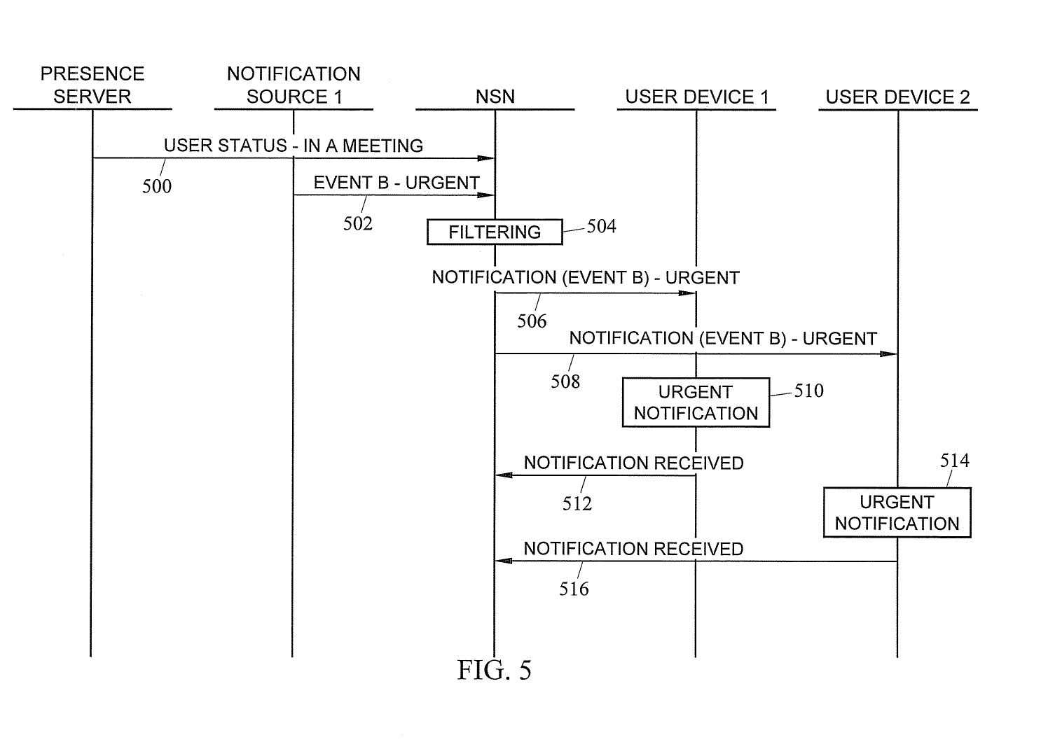

FIG. 5 is a message flow diagram illustrating the delivery of a notification designated as “urgent” to a plurality of user devices associated with a single subscriber according to an embodiment of the subject matter described herein. For example, NSN 102 receives a notification (message 500) from presence server 118 which indicates that the subscriber is presently attending a meeting. In response, NSN 102 updates the subscriber database with the most recent subscriber status. NSN 102 subsequently receives a notification (message 502) from a notification source that Event B has occurred. Notably, Event B has been designated as an “urgent” event by the notification source. In response to the urgent notification, NSN 102 accesses subscriber database 210 (block 504) to determine whether a notification message is to be delivered to the intended subscriber's user devices, e.g., user device 1 and user device 2. In FIG. 5, NSN 102 determines that a notification message should be delivered given its urgent nature to each of user device 1 and user device 2. Accordingly, NSN 102 then sends a notification message (messages 506 and 508) with an “urgent” designation that indicates the occurrence of Event B to each of user device 1 and user device 2. In blocks 510 and 514, each of user device 1 and user device 2 displays the “urgent” notification, which may be presented to the subscriber. After respectively receiving the notification messages, each of user device 1 and user device 2 then sends an acknowledgement message (messages 512 and 516) to NSN 102 that the urgent notification message has been received.

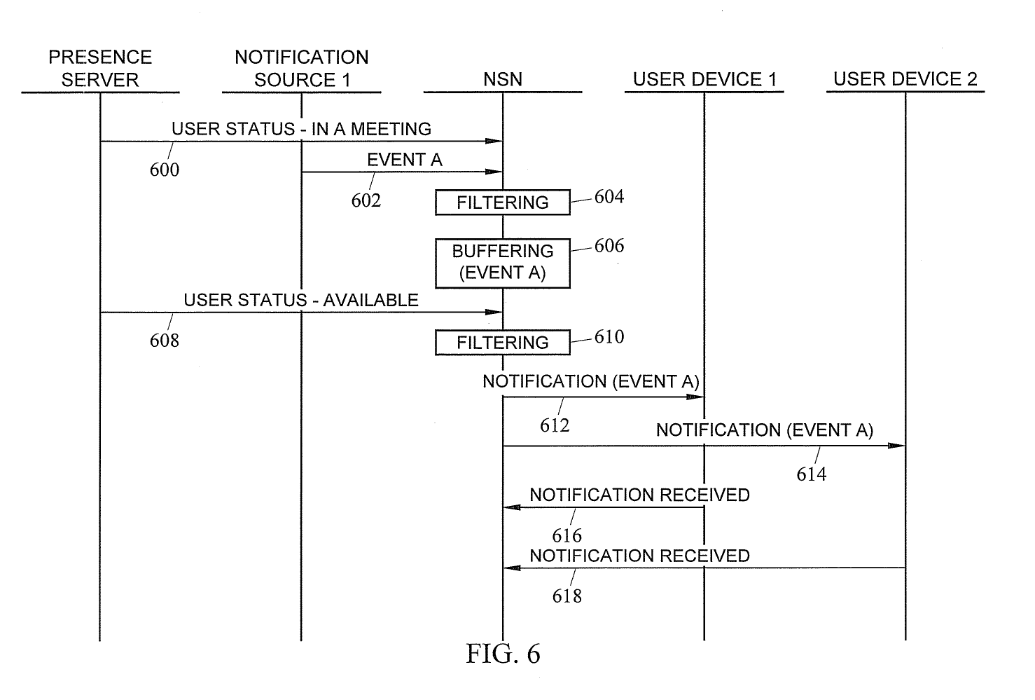

FIG. 6 is a message flow diagram illustrating the filtering and buffering of a notification according to an embodiment of the subject matter described herein. For example, NSN 102 receives a notification (message 600) from presence server 118 which indicates that the subscriber is presently attending a meeting. In response, NSN 102 updates the subscriber database with the most recent subscriber status. NSN 102 subsequently receives a notification (message 602) from notification source 1 that Event A has occurred. In response to receiving the notification, NSN 102 accesses the filter criteria associated with the subscriber and determines that the filter criteria are not met (block 604). Accordingly, NSN 102 may then buffer the notification for later delivery to the intended recipient's user devices, e.g., user device 1 and user device 2 (block 606). FIG. 6 also depicts NSN 102 subsequently receiving, from presence server 118, a user status notification (message 608) that indicates that the subscriber presence status is now available. NSN 102 may then access and evaluate the filter criteria 212 and determine that a notification message associated with the buffered notification should now be forwarded to each of user device 1 and user device 2 (block 610). Accordingly, NSN 102 sends a notification message to each of user device 1 and user device 2 indicating the occurrence of Event A (messages 612 and 614). FIG. 6 also illustrates that each of user device 1 and user device 2 sends an acknowledgement message to NSN 102 (steps 614 and 618) in response to the receipt of the notification messages.

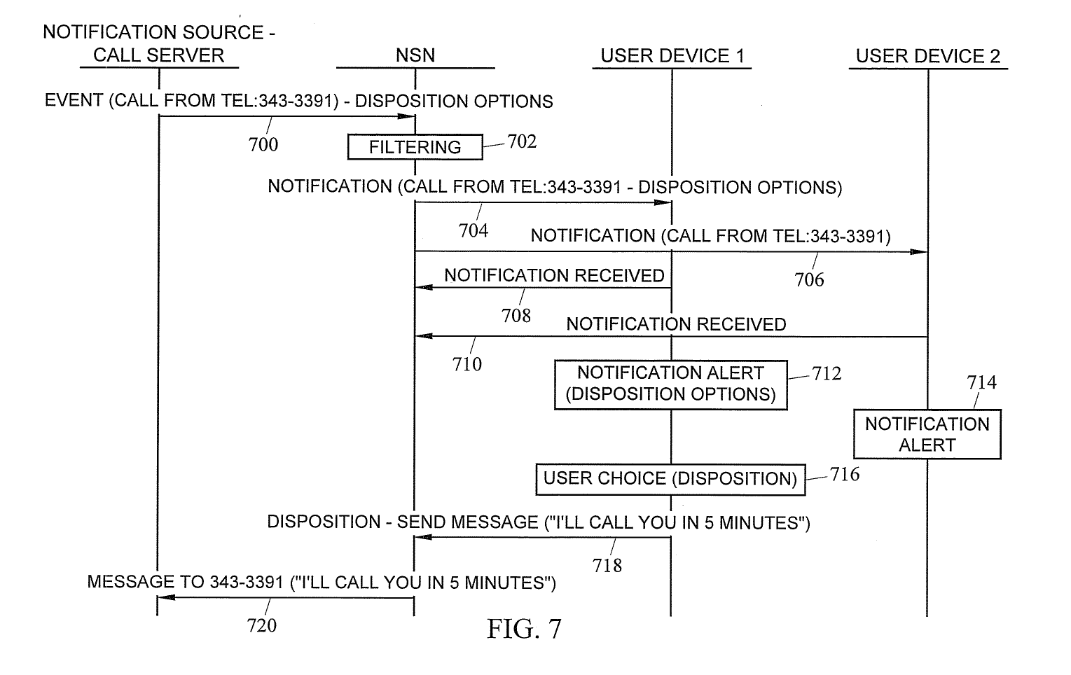

FIG. 7 is a message flow diagram illustrating the delivery of a notification message that includes disposition options to a subscriber device according to an embodiment of the subject matter described herein. For example, call server 104 sends, to NSN 102, a notification (message 700) that indicates that a call originating from 343-3391 has been received. Notably, the notification includes one or more disposition options for the called subscriber to select. Upon receiving the notification, NSN 102 conducts a filtering process (block 702) to determine whether a notification with the disposition option(s) is to be delivered to the subscriber's recipient's user devices, e.g., user device 1 and user device 2. After accessing the subscriber database, NSN 102 determines that user device 1 is capable of presenting the disposition option to the recipient and that user device 2, however, is not capable of presenting the disposition option to the recipient. Accordingly, NSN 102 sends a notification message (message 704) along with the disposition options to user device 1 and only forwards a notification message (message 704) (without the disposition options) to user device 2. In response, each of user device 1 and user device 2 sends an acknowledgement message (messages 708 and 710) to NSN 102 indicating the receipt of the notification messages. Each of user device 1 and user device 2 also issues a notification alert to the recipient to notify the recipient that a notification message has been received by the user device. Notably, user device 1 presents the notification alert that includes at least one disposition option to the recipient (block 712). User device 2, however, only presents a notification alert (block 714) that does not include disposition options. In one embodiment, the disposition option included in block 712 may include an instruction to send a text message, which indicates that the called party will respond in five minutes, to the calling party. The selection of the disposition option, i.e., the user choice (block 716), is then sent to NSN 102 via message 718. NSN 102 subsequently sends a text message toward the source of the notification, i.e., the call server servicing the calling party (message 720) and ultimately the calling party (not shown). The text message conveys that the called party will respond in five minutes.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for providing notifications to one or more subscriber devices, the system comprising:
a plurality of notification sources for providing notifications to user devices associated with a subscriber; and
a notification service node (NSN) configured to receive a notification directed to a first user device associated with the subscriber from at least one of the plurality of notification sources, to access filtering criteria associated with the subscriber to determine whether to deliver the notification to at least one user device associated with the subscriber, and to deliver a notification message associated with the notification to the at least one user device if the filtering criteria is met.

2. The system of claim 1 wherein the at least one user device includes the first user device.

3. The system of claim 1 wherein the at least one user device does not include the first user device.

4. The system of claim 1 wherein the filtering criteria is based on at least one of: user preference rules, user status, importance designation of the notification, priority designation of the notification, user device type, current user availability status, current user presence status, and current user device connectivity status.

5. The system of claim 1 wherein the NSN is further configured to buffer the notification for later delivery to the at least one user device if the filtering criteria is not met.

6. The system of claim 1 wherein the NSN is further configured to keep a temporary copy of the notifications, wherein the notifications are accessed via a web portal by the user

7. The system of claim 1 wherein the plurality of notification sources includes at least one of a call server, a voicemail server, a videomail server, a short messaging service (SMS) server, a multimedia messaging service (MMS) server, an instant messaging (IM) server, an email server, an RSS feed server, a public service alert system, and a social network server.

8. The system of claim 1 the NSN is further configured to deliver a notification message to all user devices associated with the subscriber.

9. The system of claim 1 wherein the NSN is further configured to deliver a notification message that includes at least one disposition option.

10. The system of claim 1 wherein the NSN is further configured to deliver a notification message that includes an advertisement.

11. The system of claim 10 wherein the advertisement is dependent on the content of notifications received.

12. A method for providing notification services to a subscriber device, the method comprising:
receiving, from a notification source, a notification directed to a first user device associated with a subscriber;
accessing filtering criteria associated with the subscriber to determine whether to deliver the notification to at least one user device associated with the subscriber; and
delivering a notification message associated with notification to the at least one user device if the filtering criteria is satisfied.

13. The method of claim 12 wherein the at least one user device includes a first user device.

14. The method of claim 12 wherein the at least one user device does not include the first user device.

15. The method of claim 12 wherein the filtering criteria is based on at least one of: user preference rules, user status, importance designation of the notification, priority designation of the notification, user device type, current user availability status, current user presence status, and current user device connectivity status.

16. The method of claim 12 comprising buffering the notification for later delivery to the at least one user device if the filtering criteria is not met.

17. The method of claim 16 comprising maintaining a temporary copy of the notifications, wherein the notifications can be accessed via a web portal by the user.

18. The method of claim 17 wherein the notification source includes at least one of a call server, a voicemail server, a videomail server, a short messaging service (SMS) server, a multimedia messaging service (MMS) server, an instant messaging (IM) server, an email server, an RSS feed server, a public service alert system, and a social network server.

19. The method of claim 12 wherein delivering a notification message to the at least one user device includes delivering a notification message to all user devices associated with the subscriber.

20. The method of claim 12 wherein the delivered notification message includes at least one disposition option.

21. The method of claim 12 wherein the delivered notification message includes an advertisement.

22. The method of claim 21 wherein the advertisement is dependent on the content of notifications received.

23. A non-transitory computer readable medium comprising computer executable instructions embodied in a computer readable medium and when executed by a processor of a computer performs steps comprising:
receiving, from a notification source, a notification directed to a first user device associated with a subscriber;
accessing filtering criteria associated with the subscriber to determine whether to deliver the notification to at least one user device associated with the subscriber; and
delivering a notification message associated with notification to the at least one user device if the filtering criteria is satisfied.

24. The non-transitory computer readable medium of claim 21 wherein the at least one user device includes the first user device.

25. The non-transitory computer readable medium of claim 1 wherein the at least one user device does not include the first user device.

26. The non-transitory computer readable medium of claim 12 wherein the filtering criteria is based on at least one of: user preference rules, user status, urgency designation of the notification, user device type, and current user device connectivity status.

27. The non-transitory computer readable medium of claim 21 comprising buffering the notification for later delivery to the at least one user device if the filtering criteria is not met.
